(19) United States
(12) Patent Application Publication
(10) Pub. No.: US 2010/0002620 A1
(43) Pub. Date: Jan. 7, 2010

(54) REPEATER HAVING DUAL RECEIVER OR TRANSMITTER ANTENNA CONFIGURATION WITH ADAPTATION FOR INCREASED ISOLATION

(75) Inventors: James A. Proctor, JR., Melbourne Beach, FL (US); Kenneth M. Gainey, Satellite Beach, FL (US); James C. Otto, West Melbourne, FL (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/307,801

(22) PCT Filed: Aug. 31, 2007
(86) PCT No.: PCT/US07/19163

§ 371 Date: Apr. 21, 2009

Related U.S. Application Data
(60) Provisional application No. 60/841,528, filed on Sep. 1, 2006.

(51) Int. Cl. H04B 7/14

(52) U.S. Cl. 370/315

(57) ABSTRACT

A repeater for a wireless communication network includes a reception antenna and first and second transmission antennas. The repeater also includes a weighting circuit which applies a weight to at least one of first and second signals on first and second transmission paths coupled to the first and second transmission antennas respectively, and a control circuit configured to control the weighting circuit in accordance with an adaptive algorithm to thereby increase isolation between a reception path coupled to the reception antenna and the first and second transmission paths.

### CROSS REFERENCE TO RELATED APPLICATIONS

This application is related to and claims priority from pending U.S. Provisional Application No. 60/841,528 filed Sep. 1, 2006, and is further related to: U.S. Pat. No. 7,200,134 to Proctor et al., which is entitled “WIRELESS AREA NETWORK USING FREQUENCY TRANSLATION AND RETRANSMISSION BASED ON MODIFIED PROTOCOL MESSAGES FOR ENHANCING NETWORK COVERAGE;” U.S. Patent Publication No. 2006-0098592 (U.S. application Ser. No. 10/536,471) to Proctor et al., which is entitled “IMPROVED WIRELESS NETWORK REPEATER;” U.S. Patent Publication No. 2006-0056352 (U.S. application Ser. No. 10/533,589) to Gainey et al., which is entitled “WIRELESS LOCAL AREA NETWORK REPEATER WITH DETECTION;” and U.S. Patent Publication No. 2007-0117514 (U.S. application Ser. No. 11/602,455) to Gainey et al., which is entitled “DIRECTIONAL ANTENNA CONFIGURATION FOR TDD REPEATER,” the contents all of which are incorporated herein by reference.

### TECHNICAL FIELD

The technical field relates generally to a repeater for a wireless communication network, and, more particularly, to an antenna configuration associated with the repeater.

### BACKGROUND

Conventionally, the coverage area of a wireless communication network such as, for example, a Time Division Duplex (TDD), Frequency Division Duplex (FDD) Wireless-Fidelity (Wi-Fi), Worldwide Interoperability for Microwave Access (Wi-max), Cellular, Global System for Mobile communications (GSM), Code Division Multiple Access (CDMA), or 3G based wireless network can be increased by a repeater. Exemplary repeaters include, for example, frequency translating repeaters or same frequency repeaters which operate in the physical layer or data link layer as defined by the Open Systems Interconnection Basic Reference Model (OSI Model).

A physical layer repeater designed to operate within, for example, a TDD based wireless network such as Wi-max, generally includes antenna modules and repeater circuitry for simultaneously transmitting and receiving TDD packets. Preferably, the antennas for receiving and transmitting as well as the repeater circuitry are included within the same package in order to achieve manufacturing cost reductions, ease of installation, or the like. This is particularly the case when the repeater is intended for use by a consumer as a residential or small office based device where form factor and ease of installation is a critical consideration. In such a device, one antenna or set of antennas usually face, for example, a base station, access point, gateway, or another antenna or set of antennas facing a subscriber device.

For any repeater which receives and transmits simultaneously, the isolation between the receiving and transmitting antennas is a critical factor in the overall performance of the repeater. This is the case whether repeating to the same frequency or repeating to a different frequency. That is, if the receiver and the transmitter antennas are not isolated properly, the performance of the repeater can significantly deteriorate. Generally, the gain of the repeater cannot be greater than the isolation to prevent repeater oscillation or initial de-sensitization. Isolation is generally achieved by physical separation, antenna patterns, or polarization. For frequency translating repeaters, additional isolation may be achieved utilizing band pass filtering, but the antenna isolation generally remains a limiting factor in the repeater's performance due to unwanted noise and out of band emissions from the transmitter being received in the receiving antenna's in-band frequency range. The antenna isolation from the receiver to transmitter is an even more critical problem with repeaters operating on the same frequencies and the band pass filtering does not provide additional isolation.

Often cellular based systems have limited licensed spectrum available and can not make use of frequency translating repeating approaches and therefore must use repeaters utilizing the same receive and transmit frequency channels. Examples of such cellular systems include FDD systems such as IS-2000, GSM, or WCDMA or TDD systems such as Wi-Max (IEEE802.16), PHS, or TDS-CDMA.

As mentioned above, for a repeater intended for use with consumers, it would be preferable to manufacture the repeater to have a physically small form factor in order to achieve further cost reductions, ease of installation, and the like. However, the small form can result in antennas disposed in close proximity, thereby exasperating the isolation problem discussed above.

The same issues pertain to frequency translation repeaters, such as the frequency translation repeater disclosed in International Application No. PCT/US03/16208 and commonly owned by the assignee of the present application, in which receive and transmit channels are isolated using a frequency detection and translation method, thereby allowing two WLAN (IEEE 802.11) units to communicate by translating packets associated with one device at a first frequency channel to a second frequency channel used by a second device. The frequency translation repeater may be configured to monitor both channels for transmissions and, when a transmission is detected, translate the received signal at the first frequency to the other channel, where it is transmitted at the second frequency. Problems can occur when the power level from the transmitter incident on the front end of the receiver is too high, thereby causing inter-modulation distortion, which results in so called “spectral re-growth.” In some cases, the inter-modulation distortion can fall in-band to the desired received signal, thereby resulting in a jamming effect or de-sensitization of the receiver. This effectively reduces the isolation achieved due to frequency translation and filtering.

### SUMMARY

In view of the above problems, various embodiments of a repeater include an adaptive antenna configuration for either the receivers, transmitters or both to increase the isolation and thereby provide higher receiver sensitivity and transmission power.

According to a first embodiment, the repeater can include a reception antenna, first and second transmission antennas, a weighting circuit for applying a weight to at least one of first and second signals on first and second transmission paths coupled to the first and second transmission antennas, respectively; and a control circuit configured to control the weighting circuit in accordance with an adaptive algorithm to thereby increase isolation between a reception path coupled to the reception antenna and the first and second transmission paths.

According to a second embodiment, the repeater can include first and second reception antennas, a transmission antenna, and a weighting circuit for applying a weight to at least one of first and second signals on first and second reception paths coupled to the first and second reception antennas, respectively. The repeater further includes a combiner for combining the first and second signals into a composite signal after the weight has been applied to at least one of the first and second signals; and a controller for controlling the weighting circuit in accordance with an adaptive algorithm to thereby increase isolation between the first and second reception paths and a transmission path coupled to the transmission antenna.

According to a third embodiment, the repeater can include first and second receivers coupled to first and second reception antennas and a transmitter coupled to a transmission antenna, the first and second receivers receiving on first and second frequencies until an initial packet detection, and receiving on a same frequency after the initial packet detection. The repeater can further include a directional coupler for receiving first and second signals from the first and second reception antennas, respectively, and outputting different algebraic combinations of the first and second signals to the first and second receivers; and a baseband processing module coupled to the first and second receivers, the baseband processing module calculating multiple combinations of weighted combined signals, and selecting a particular combination of the calculated multiple combinations to determine first and second weights to apply to the first and second receivers. The baseband processing module can select a combination having most optimum quality metric as the particular combination to determine the first and second weights. The quality metric can include at least one of signal strength, signal to noise ratio, and delay spread.

According to a fourth embodiment, the repeater can include first and second receivers receiving first and second reception signals via first and second reception antennas; first and second transmitters transmitting first and second transmission signals via first and second transmission antennas; and a baseband processing module coupled to the first and second receivers and to the first and second transmitters. The baseband processing module can be configured to: calculate multiple combinations of weighted combined reception signals and select a particular combination of the calculated multiple combinations to determine first and second reception weights to apply to the first and second reception signals; and determine first and second transmission weights to apply to the first and second transmission signals.

The baseband processing module can be further configured to: measure received signal strength during packet reception; determine an isolation metric between the first and second receivers and the first and second transmitters based upon the measured received signal strength; determine the first and second transmission weights and the first and second reception weights in accordance with successive weight settings; and adjust the first and second transmission weights and the first and second reception weights in accordance with the adaptive algorithm to increase the isolation metric between the first and second receivers and the first and second transmitters.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention

FIG. 1A is a diagram illustrating an exemplary enclosure for a dipole dual patch antenna configuration.

FIG. 1B is a diagram illustrating an internal view of the enclosure of 1A.

FIG. 2 is a diagram illustrating an exemplary dual dipole dual patch antenna configuration.

FIGS. 3A-3B are block diagrams of a transmitter based adaptive antenna configuration in accordance with various exemplary embodiments.

FIG. 4 is a block diagram of a receiver based adaptive antenna configuration in accordance with various exemplary embodiments.

FIG. 5 is a block diagram of a testing apparatus used to test a transmitter based adaptive antenna configuration.

FIG. 6 are graphs illustrating the gain verses frequency and phase shift verses frequency for the antenna with no adaptation according to a first test.

FIG. 7 are graphs illustrating the gain verses frequency and phase shift verses frequency for the antenna with adaptation according to the first test.

FIG. 8 are graphs illustrating the gain verses frequency and phase shift verses frequency for the antenna with no adaptation according to a second test.

FIG. 9 are graphs illustrating the gain verses frequency and phase shift verses frequency for the antenna with adaptation according to the second test.

FIG. 10 is a block diagram of an exemplary adaptive antenna configuration in accordance with various exemplary embodiments.

### DETAILED DESCRIPTION

An adaptive antenna configuration is disclosed and described herein for a wireless communication node such as a repeater. The repeater can be, for example, a frequency translating repeater such as disclosed in U.S. Pat. No. 7,200,134 or U.S. Patent Publication No. 2006-0098592, both to Proctor et al., a same frequency translation antenna such as the time divisional duplex (TDD) repeaters disclosed in U.S. Patent Publication No. 2007-0117514 to Gainey et al. and U.S. Pat. No. 7,233,771 to Procter et al., as well as Frequency Division Duplex (FDD) repeaters.

The adaptive antenna configuration can include dual receive antennas, dual transmit antennas, or both dual receive and transmit antennas. Further, each antenna may be of various types including patch antennas, dipoles or other antenna types. For example, one or two dipole antennas and two patch antennas may be used in one configuration, with one group for wireless reception and the other for wireless transmission. The two patch antennas can be disposed in parallel relation to each other with a ground plane arranged therebetween. A portion of the ground plane can extend beyond the patch antennas on one or both sides. Circuitry for the repeater can further be arranged on the ground plane between the patch antennas and thus can be configured for maximum noise rejection. For example, to reduce generalized coupling through the ground plane or repeater circuit board substrate, the antennas can be driven in a balanced fashion such that any portion of a signal coupling into the feed structure of another antenna will be common mode coupling for maximum cancellation. To further improve isolation and increase link efficiency, an isolation fence can be used between the patch antennas and the dipole antennas. As another approach, all four antennas may be patch antennas with two on each side of the board

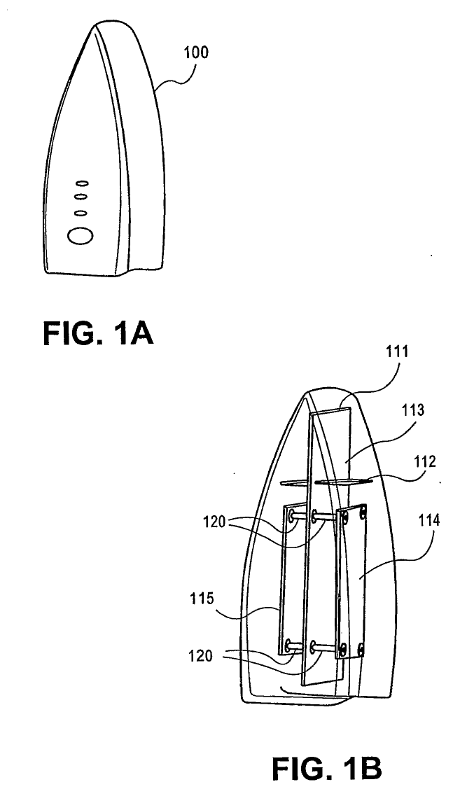

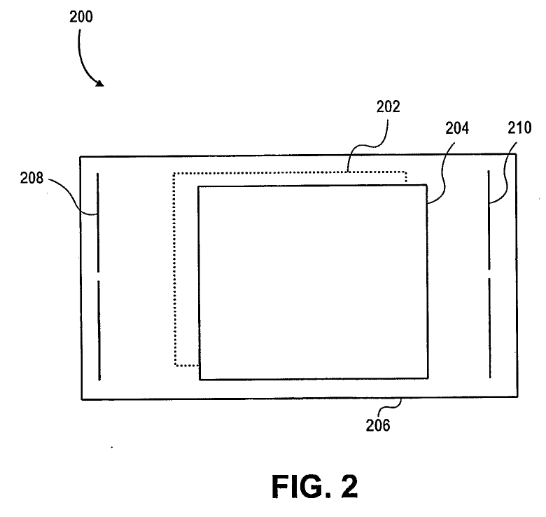

As another example, a dipole dual patch antenna configuration for a repeater in which an adaptive antenna configuration according to various embodiments can be implemented is shown in FIGS. 1A-1B. The dipole dual patch antenna configuration along with the repeater electronics can be efficiently housed in a compact enclosure 100 as shown in FIG. 1A. The structure of the enclosure 100 can be such that it will be naturally oriented in one of two ways; however, instructions can guide a user in how to place the enclosure to maximize signal reception. The exemplary dipole dual patch antenna configuration is shown in FIG. 1B, where a ground plane 113, preferably incorporated with a printed circuit board (PCB) for the repeater electronics can be arranged in parallel between two patch antennas 114 and 115 using, for example, standoffs 120. An isolation fence 112 can be used as noted above to improve isolation in many instances.

Each of the patch antennas 114 and 115 are arranged in parallel with the ground plane 113 and can be printed on wiring board or the like, or can be constructed of a stamped metal portion embedded in a plastic housing. A planar portion of the PCB associated with the ground plane 113 can contain a dipole antenna 111 configured, for example, as an embedded trace on the PCB. Typically, the patch antennas 114 and 115 are vertically polarized and the dipole antenna 111 is horizontally polarized.

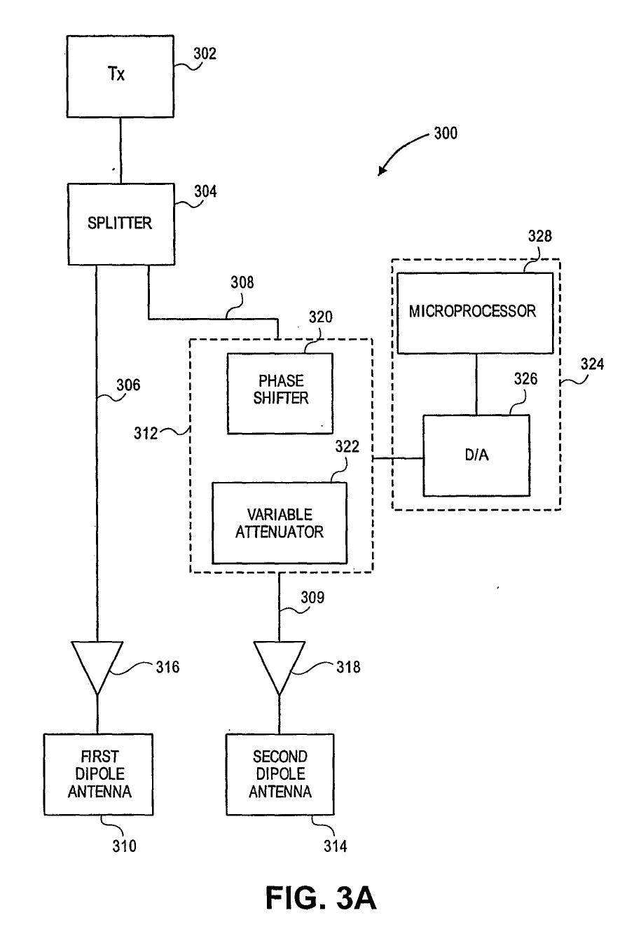

An exemplary dual dipole dual patch antenna configuration for a repeater in which an adaptive antenna configuration according to various embodiments can be implemented is shown in FIG. 2. The dual dipole dual patch antenna configuration 200 includes first and second patch antennas 202, 204 separated by a PCB 206 for the repeater electronics. First and second dipole antennas 208, 210 are disposed on opposite sides of a planar portion of the PCB by, for example, standoffs. Similarly to the antenna configuration 100 discussed above, the dipole antennas 208, 210 can be configured as embedded traces on the PCB 206.

A combination of non-overlapping antenna patterns and opposite polarizations can be utilized to achieve approximately 40 dB of isolation between the receiving and transmitting antennas in a dual dipole dual patch antenna. Particularly, one of the transmitter and the receiver uses one of two dual switched patch antennas having vertical polarization for communication with an access point, while the other of the of the transmitter and the receiver uses the dipole antenna having horizontal polarization. This approach would be particularly applicable when the repeater is meant to repeat an indoor network to indoor clients. In this case the antenna pattern of the antennas transmitting to the clients would need to be generally omni-directional, requiring the use of the dual dipole antennas, as the direction to the clients is not known.

As an alternative embodiment, two patch antennas may be used on each side of the PCB when the repeater is intended to be used for repeating a network from the outside to the inside of a structure. Referring again to FIG. 2, each of the dual dipole antennas 208 and 210 may be replaced with additional patch antennas. In this embodiment two patch antennas would be on each side of the PCB, with each of the new patch antennas adjacent to the patch antennas 202 and 204. In this case isolation in excess of 60 dB can be achieved. In this embodiment, two patch antennas would be used for receiving and two patch antennas would be used for transmitting. This embodiment would be particularly applicable to situations where the repeater is placed in a window and acting as an “outside to inside” repeater and/or visa versa. In this case the antennas transmitting to the clients may be directional as the direction to the clients is generally known and limited to the antennas facing inside the structure.

Additional isolation can be achieved by frequency translation and channel selective filtering. However, as discussed above, inter-modulation distortion can fall in-band to the desired received signal, thereby resulting in a jamming effect or de-sensitization of the receiver. This effectively reduces the isolation achieved due to frequency translation and filtering.

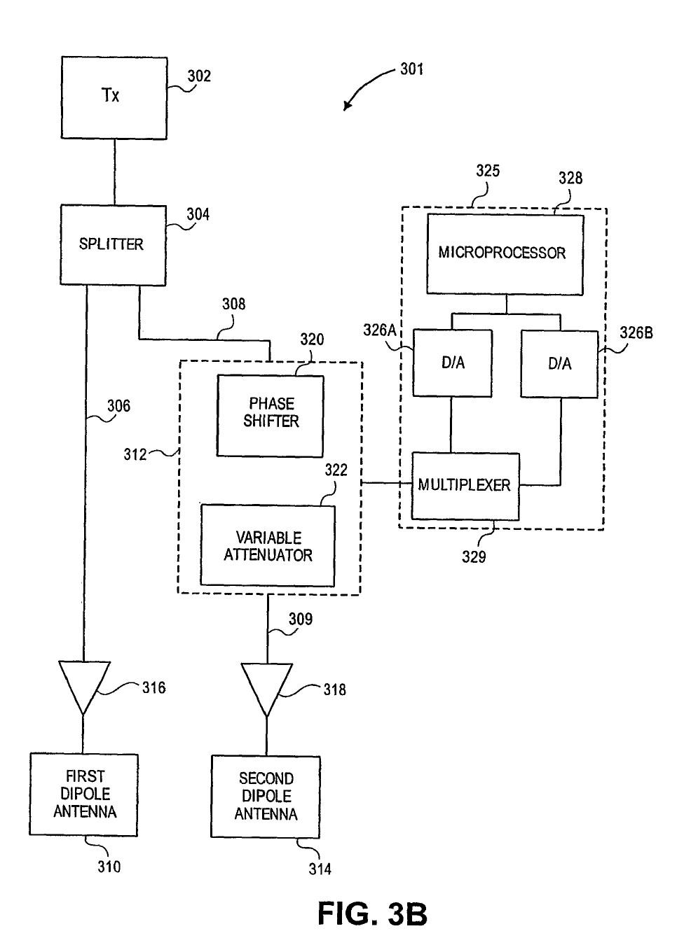

Referring to FIG. 3A, a transmitter based adaptive antenna configuration 300 which can be implemented in the dual dipole dual patch antenna configuration shown in FIG. 2 will be discussed. The configuration 300 includes a transmitter 302 and a radio frequency (RF) splitter 304 such as, for example, a Wilkinson divider, for splitting the transmitter output into a first path 306 and a second path 308. The first path 306 drives a first dipole antenna 310, while the second path 308 passes through a weighting circuit 312. The output 309 of the weighting circuit 312 drives a second dipole antenna 314. Further, first and second power amplifiers 316, 318 can be respectively disposed on the first and second paths 306, 308 just before the respective dipole antennas. Alternatively, only one power amplifier could be disposed before the splitter 304; however this configuration may lead to loss of transmission power and efficiency due to loss in the weighting circuit 312.

The weighting circuit 312 is generally for modifying the weight (gain and phase) of the signal on the second path 308 in comparison to the signal on the first path 306. The weighting circuit 312 can include, for example, a phase shifter 320 and a variable attenuator 322. A control circuit 324 coupled to the weighting circuit 312 determines and sets the appropriate weight values for the weighting circuit 312. The control circuit 324 can include a Digital to Analog Converter (D/A) 326 for setting the weight values and a microprocessor 328 for executing an adaptive algorithm to determine the weight values.

The adaptive algorithm executed by the microprocessor 328 can use metrics such as a beacon transmitted by the repeater during normal operation for determining the weight values. For example, for a frequency translating repeater operating on two frequency channels, the receiver (not shown) can measure received signal strength on one channel while the two transmitting antennas can transmit a self generated signal such as the beacon. The signal must be self-generated so that the repeated signal can be distinguishable from the transmitted signal leaking back into the same receiver. The amount of initial transmitter to receiver isolation can be determined during self generated transmissions (as opposed to repeating periods). The weights can be adjusted between subsequent transmissions using any number of known minimization adaptive algorithms such as steep descent, or statistical gradient based algorithms such as the LMS algorithm to thereby minimize coupling between the transmitters and receiver (increase isolation) based upon the initial transmitter to receiver isolation. Other conventional adaptive algorithms which will adjust given parameters (referred to herein as weights) and minimize a resulting metric can also be used. In this example, the metric to be minimized is the received power during the transmission of a beacon signal.

Alternatively, the transmitter based adaptive antenna configuration 300 can be implemented in the dipole dual patch antenna shown in FIG. 1. Here, the two patch antennas rather than the two dipole antennas can be coupled to the power amplifiers, and the receiver can be coupled to a single dipole. The weighting circuit would be similar to as shown in FIG. 3A.

Referring to FIG. 3B, a transmitter based adaptive antenna configuration 301 which can be implemented within a frequency translating repeater capable of transmitting and receiving on two different frequencies will be briefly discussed. In such a frequency translating repeater, different weights must be used for the weighting structure depending on which of the two frequencies is being used for transmission. Accordingly, the configuration 301 includes first and second D/A converters 326A, 326B for applying first and second weights. The control circuit 325 (microprocessor 328) can determine which weight to apply prior to the operation by the D/A converters 326A, 326B. More preferably, an analog multiplexer 329 coupled to the weighting circuit 312 can switch each of the control voltages between two weight settings depending on which of the two frequencies are being transmitted.

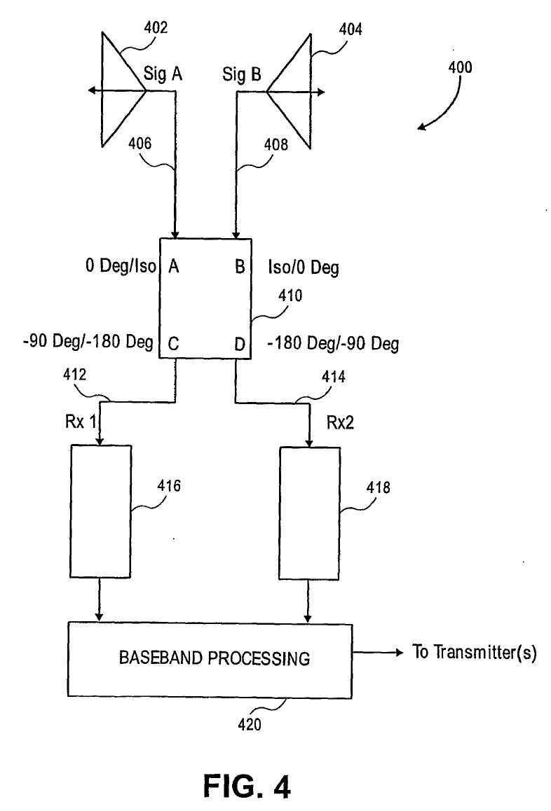

Referring to FIG. 4, a receiver based adaptive antenna configuration 400 which can be implemented in the antenna configuration for a repeater shown in FIG. 2 will be discussed. The configuration 400 includes first and second patch antennas 402, 404 and a directional coupler 410 for combining the signals A, B on paths 406, 408 from the first and second patch antennas 402, 404 so that first and second receivers 416, 418 coupled to the directional coupler 410 receive a different algebraic combination of the signals A, B. In this embodiment, the directional coupler 410 is a 90° hybrid coupler including two input ports A, B for receiving the signals A, B from the first and second patch antennas 402, 404 and two output ports C, D for outputting different algebraic combinations of the signals A, B on paths 412, 414 to the first and second receivers 416, 418. The outputs of the first and second receivers 416, 418 are coupled to a baseband processing module 420 for combining the signals to perform a beam forming operation in digital baseband. It is important that the combination output to the first and second receivers 416, 418 be unique, otherwise, both receivers 416, 418 will receive the same combined signal, and after detection, would not gain any benefit from an algebraic combination of the two signals to gain a third unique antenna pattern. This uniqueness is ensured by the use of directional antennas (402, and 404) and the coupler 410. This approach has the advantage of permitting the first receiver 416 to be tuned to one frequency while the other receiver 418 is tuned to another frequency, yet a signal from either of the two directional antennas will be received by one of the receivers depending on which frequency the signal is operating on, but independent of the signal's direction of arrival. This approach has the further advantage, as mentioned above, that once a signal is detected on one of the two frequencies the other receiver may be retuned to the detected frequency. This approach allows for the algebraic combination of signals A (406) and B (408) to be recovered from signals C (412) and D (414) once the receivers are both tuned to the same frequency following signal detection.

The repeater will also include first and second transmitters (not shown) coupled to the first and second dipole antennas (See FIG. 2). As mentioned above, during repeater operation prior to the detection and repeating of a packet, the first and second receivers 416, 418 operate on first and second frequencies to detect the presence of signal transmitted on one of the two frequencies. After detecting a signal packet for example from an access point, both of the first and second receivers 416, 418 can be tuned to the same frequency. Here, the signals A, B from the first and second patch antennas 402, 404 are combined in the directional coupler 410.

The operation of the adaptive antenna configuration 400 will be discussed by way of an example in which port A of the 90° hybrid coupler produces a −90° phase shift to port C and a −1800 phase shift to port D, and port B conversely produces a −90° phase shift to port D, and a −180° phase shift to port C. Thus, when signals A, B are driven into the two ports A and B, the outputs are a unique algebraic combination of the two input signals. Because these two outputs are unique, they can be recombined to recover any combination of the original signals A, B or any mixture by the baseband processing module 420. As shown in FIG. 4, the signal into the first receiver 416 (Rx1)=A at −90°+B at −180°, and the signal into the second receiver 418 (Rx2)=A at 180°+B at −90°. The baseband processing module 420 can perform a recombination of the signals according to, for example, the formula Rx1 at +90°+Rx2. Thus, the recombined signals becomes A at +180°+B at −90°+A at −180°+B at −90°, and finally 2B at −90°, effectively recovering the antenna pattern of signal B.

This configuration 400 allows for the first and second receivers 416, 418 to have an almost omni-directional pattern when tuned to different frequencies during the detection phase of the repeater. Then, after they are retuned to the same frequency following detection, the signals may be combined to perform a beam forming operation in digital baseband.

In this manner, the first and second receivers 416, 418 can then have weights applied and perform a receiver antenna adaptation. The application of the weights would preferably be applied digitally at the baseband processing module 420, but could also be applied in analog in receivers 416 and 418. When the adaptation is preferable implemented as a digital weighting in baseband, the decision of the weighting may be achieved by calculating the “beam formed” or weighed combined signals in multiple combinations simultaneously, and selecting the best combination of a set of combinations. This may be implemented as a fast Fourier transform, a butler matrix of a set of discrete weightings, or any other technique for producing a set of combined outputs, and selecting the “best” from among the outputs. The “best” may be based on signal strength, signal to noise ratio (SNR), delay spread, or other quality metric. Alternatively, the calculation of the “beam formed” or weighed combined signal may be performed sequentially. Further, the combination may be performed in any weighting ratios (gain and phase, equalization) such that the best combination of the signals A, B from the first and second patches antennas 402, 404 is used.

When the repeater uses two receivers and two transmitters, a weight can be applied on one leg of the receivers and a different weight on one leg of the transmitters. In this case, the transmitters will be connected each to one of the two printed dipole antennas. This will allow for a further performance benefit by adapting the antennas to increase the receiver to transmitter isolation far beyond that provided by the antenna design alone.

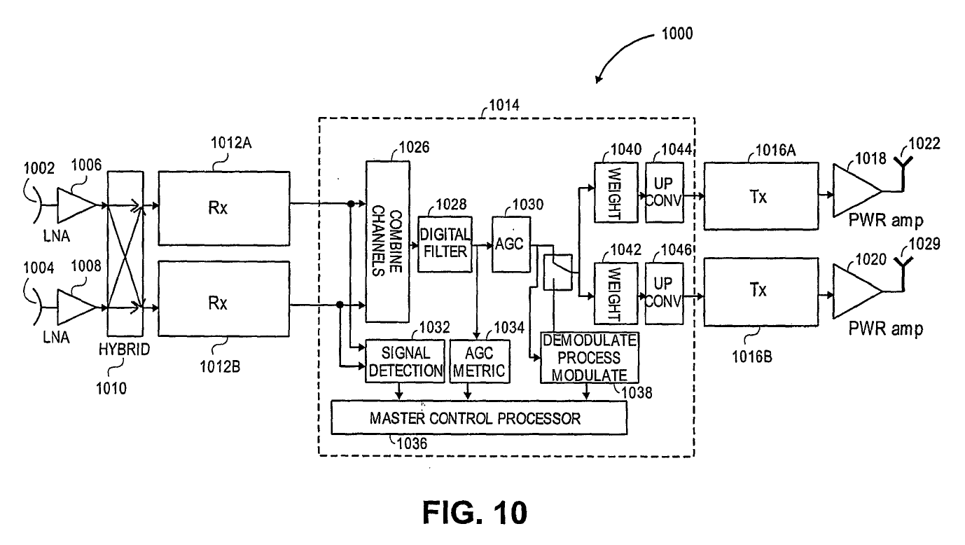

Referring to FIG. 10, a block diagram of another adaptive antenna configuration 1000 will be discussed. In this configuration 1000, weights can be applied to both the receiver and transmitter paths to achieve higher isolation. The configuration 1000 can be employed in, for example, the antenna configuration 200 shown in FIG. 2. The configuration 1000 includes first and second reception antennas 1002, 1004 which are respectively coupled to first and second low noise amplifiers (LNAs) 1006, 1008 for amplifying the received signals. The first and second reception antennas 1002, 1004 can be, for example, patch antennas. The outputs of the LNAs 1006, 1008 are coupled to a hybrid coupler 1010, which can be configured similarly to the hybrid coupler 410 shown in FIG. 4. The hybrid coupler 1010 is coupled to first and second receivers 1012A, 1012B, which are coupled to the baseband processing module 1014. A transmitter 1016, which can also be two components, is coupled to the outputs of the baseband processing 1014. The transmitter 1016 is coupled to first and second transmission antennas 1022, 1024 via first and second power amplifiers 1018, 1020. The first and second transmission antennas 1022, 1024 can be, for example, dipole antennas.

The baseband processing module 1014 includes a combiner 1026 (COMBINE CHANNELS) for combining the channels from the receivers 1012A, 1012B, a digital filter 1028 for filtering the signal, and an adjustable gain control (AGC) 1030 for adjusting the signal gain. The baseband processing module 1014 also includes a signal detection circuit 1032 for detecting signal level, an AGC metric 1034 for determining parameters for gain adjustment, and a master control processor 1036. The signal from the AGC 1030 is output to weight elements 1040, 1042 and a demodulater/modulater (DEMODULATE PROCESS MODULATE) 1038 for performed any needed signal modulation or demodulation. The weight elements 1040, 1042 can be analog elements similar to the weight circuit 312 or digital elements. The weight elements 1040, 1042 are coupled to upconversion circuits 1044, 1046, the outputs of which are coupled to the transmitter 1016.

In comparison to the configuration shown in FIGS. 3A-3B, the configuration 1000 can apply weights to both of the transmitter paths digitally by the baseband processing 1014, rather than only in analog by the weighting circuit 312. Alternatively, the baseband processing 1014 can only apply weights digitally to the receiver paths, while an analog circuit applied weights to the transmitter paths. In this case, the weight elements 1040, 1042 can be analog elements. The processor 1036 can be programmed to perform the adaptive algorithm for adjusting the weights and to calculate the beam formed as discussed above.

As mentioned earlier, the metrics to adapt the antenna to achieve isolation can be based upon measuring transmitted signals in the receivers (e.g., signal detection 1032) during time periods where the repeater is self generating a transmission, with no reception. In other words, the physical layer repeating operation is not being performed, and no signal is being received, but the transmitter is sending a self generated transmission. This allows for a direct measurement of the transmitter to receiver isolation, and an adaptation of the weights to maximize isolation.

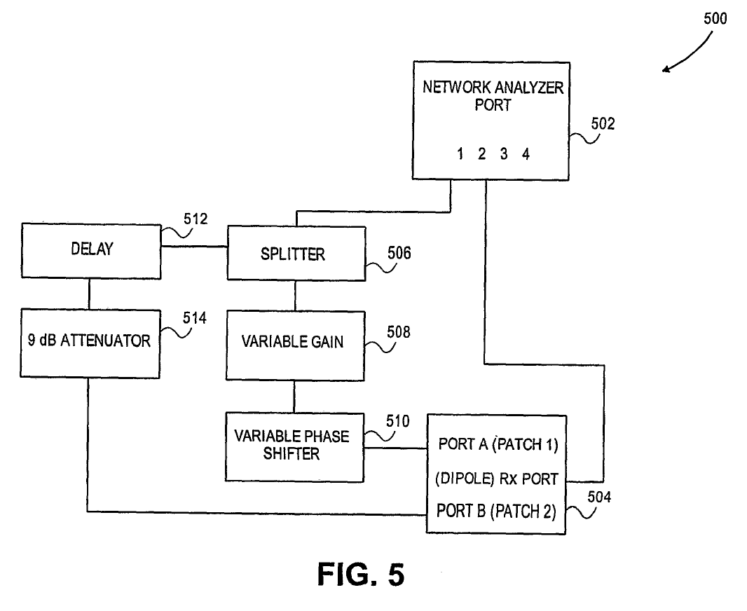

The inventors performed several tests demonstrating the higher isolation achieved by the adaptive antenna configuration of the various exemplary embodiments. FIG. 5 is a block diagram of a testing apparatus used to test the adaptive antenna configuration. A network analyzer 502 was used to obtain performance data of a dipole patch array 504 similar to the one shown in FIG. 1B. Particularly, an output of the network analyzer 502 is coupled to a splitter 506. A first output of the splitter 506 is coupled to a weight circuit composed of a variable gain 508 and variable phase shifter 510 connected together in series. The other output of the splitter 506 is coupled to a delay 512 and a 9 dB attenuator 514, which compensate for delay and signal loss experienced on the first path and result in balanced paths. The output of the variable phase shifter 510 drives a first patch antenna of the dipole patch array 504, and the output of the 9 dB attenuator drives a second patch antenna of the dipole patch array 504. A dipole antenna of the dipole patch array 504 receives the combined transmissions, and is coupled to the input of the network analyzer 502.

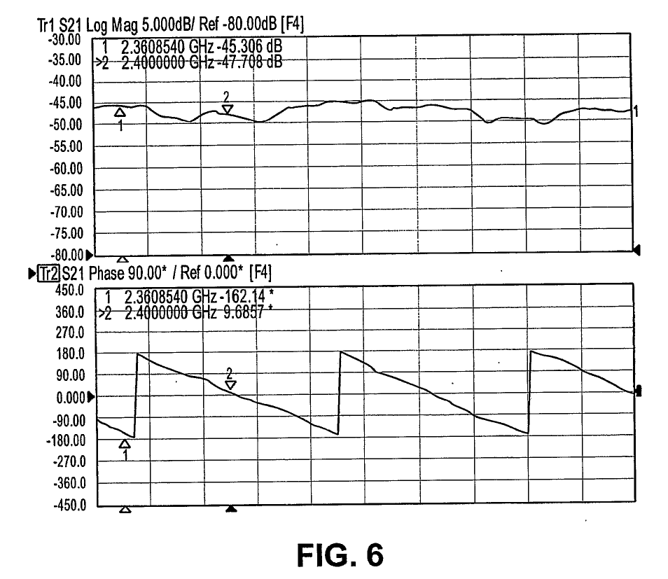

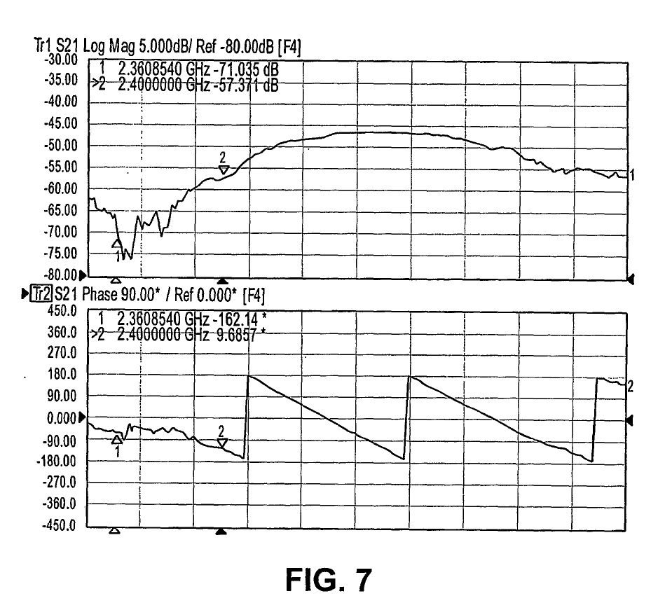

Referring to FIGS. 6-7, the path loss was measured at 2.36 GHz (marker 1) and at 2.40 GHz (marker 2) for the dipole patch array without the weighting circuit (no adaptation) and for the dipole patch array with the weighting circuit (adaptation) in a location with few signal scattering object physically near the antenna array 504. The results demonstrated that adjusting the phase and gain setting achieves substantial control of the isolation at specific frequencies. Particularly, marker 1 in FIG. 6 shows −45 dB of S21 path loss when no adaptation is applied, while marker 1 in FIG. 7 showed −71 dB of path loss after tuning of variable phase and gain. The result is an additional 26 dB isolation benefit. Marker 2 in FIG. 6 shows −47 dB of S21 path loss when no adaptation is applied, while marker 2 in FIG. 7 shows −57 dB of path loss after tuning of variable phase and gain. The result is an additional 10 dB isolation benefit. Further, although these two markers are roughly 40 MHz apart in frequency, they may be made broadband by using an equalizer. If the desired signal is only 2 to 4 MHz of bandwidth, no equalization would be required in this case to achieve in excess of 25 dB of increased isolation.

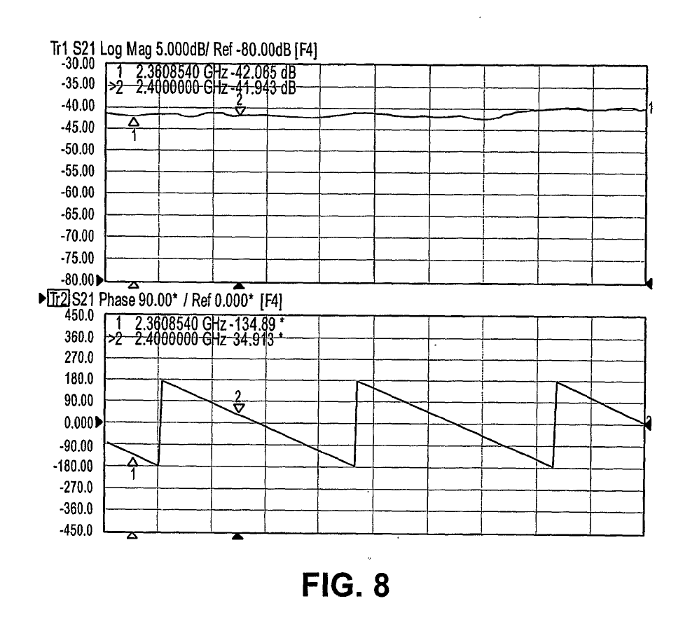

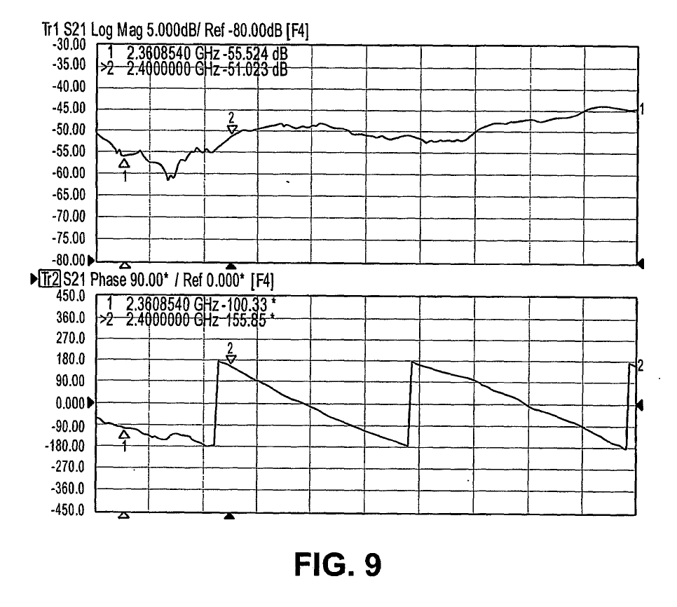

Referring to FIGS. 8-9, the path loss was again measured at 2.36 GHz (marker 1) and at 2.40 GHz (marker 2) first for the dipole patch array without the weighting circuit (no adaptation) and for the dipole patch array with the weighting circuit (adaptation) near a metal plate which is intended to act as a signal scatterer and provide a worst case operating environment with signal reflections reducing the isolation benefit which would be achieved without adaptive approaches. The results once again demonstrated that adjusting the phase and gain setting achieves substantial control of the isolation at specific frequencies. Particularly, markers 1 and 2 in FIG. 8 show −42 dB and −41.9 dB of S21 path loss when no adaptation is applied. Markers 1 and 2 in FIG. 9 showed −55 dB and −51 dB of path loss after tuning of variable phase and gain. The result is an additional 13 dB isolation benefit at 2.36 GHz and 9 dB isolation benefit at 2.40 GHz. Further, additional isolation of approximately 20 dB is achieved between the two markers.

Note that the course and limited nature of the phase and gain adjustments limit the cancellation. Significantly more cancellation is expected to be achieved with components designed for greater precision and a higher range. Further, the use of a microprocessor in performing the adaptation allows for a more optimal cancellation. Finally, using an independently adjustable frequency dependent gain and phase adjustment (equalizer) would allow for cancellation of a broader band width.

In accordance with some embodiments, multiple antenna modules can be constructed within the same repeater or device, such as multiple directional antennas or antenna pairs as described above and multiple omni or quasi-omni-directional antennas for use, for example, in a multiple-input-multiple-output (MIMO) environment or system. These same antenna techniques may be used for multi-frequency repeaters such as FDD based systems where a downlink is on one frequency and an uplink is present on another frequency.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention. The various circuits described above can be implemented in discrete circuits or integrated circuits, as desired by implementation. Further, portions of the invention may be implemented in software or the like as will be appreciated by one of skill in the art and can be embodied as methods associated with the content described herein.

What is claimed is:

1. A repeater for a wireless communication network, the repeater including a reception antenna and first and second transmission antennas, the repeater comprising:
a weighting circuit for applying a weight to at least one of first and second signals on first and second transmission paths coupled to the first and second transmission antennas, respectively; and
a control circuit configured to control the weighting circuit in accordance with an adaptive algorithm to thereby increase isolation between a reception path coupled to the reception antenna and the first and second transmission paths.

2. The repeater of claim 1, wherein the weighting circuit includes a variable phase shifter for adjusting a phase of the at least one of the first and second signals.

3. The repeater of claim 1, further comprising:
a transmitter for transmitting a self-generated signal on the first and second transmission paths; and
a receiver for measuring a received signal strength during packet reception,
wherein the control circuit is further configured to determine an initial isolation metric between the reception path and the first and second transmission paths based upon at least the measured received signal strength, and to control the weighting circuit to adjust the weight in accordance with the adaptive algorithm, wherein the adaptive algorithm includes minimizing the received signal strength of the self-generated signal.

4. The repeater of claim 1, wherein the controller includes a digital to analog converter for setting weight values of the weight circuit, and a microprocessor for controlling the digital to analog converter based upon the adaptive algorithm.

5. The repeater of claim 1, wherein the repeater is a frequency translating repeater capable of transmitting and receiving on first and second frequencies, wherein the repeater further comprises an analog multiplexer coupled to the weighting circuit to switch the weighting circuit between first and second weight settings depending on which of the first and second frequencies is being transmitted.

6. The repeater of claim 1, wherein the repeater is a frequency translating repeater capable of transmitting and receiving on first and second frequencies, wherein the controller switches the weighting circuit between first and second weight settings depending on which of the first and second frequencies is being transmitted.

7. The repeater of claim 1, wherein the repeater is a Time Division Duplex repeater and the wireless communication network is one of a Wireless-Fidelity (Wi-Fi), and Worldwide Interoperability for Microwave Access (Wi-max) network.

8. The repeater of claim 1, wherein the repeater is a Frequency Division Duplex repeater and the wireless communication network is one of a cellular, Global System for Mobile communications (GSM), Code Division Multiple Access (CDMA), and Third-Generation (3G) network.

9. The repeater of claim 1, wherein the reception antenna is a dipole antenna and the first and second transmission antennas are first and second patch antennas.

10. The repeater of claim 1, wherein the repeater is a same frequency repeater which transmits on the first and second transmission paths and receives on the reception path at a same frequency.

11. The repeater of claim 1, further comprising:
a transmitter; and
a radio frequency (RF) splitter coupled to the transmitter for splitting an output of the transmitter into the first and second signals on the first and second transmission paths.

12. The repeater of claim 1, wherein the weighting circuit includes a variable attenuator for adjusting a gain of the at least one of the first and second signals.

13. The repeater of claim 1, further comprising a transmitter, the transmitter including a radio frequency (RF) splitter coupled to the transmitter for splitting the output of the transmitter into the first and second signals on the first and second transmission paths, and the weighting circuit.

14. A repeater for a wireless communication network, the repeater including first and second reception antennas, and a transmission antenna, the repeater comprising:
a weighting circuit for applying a weight to at least one of first and second signals on first and second reception paths coupled to the first and second reception antennas, respectively;
a combiner for combining the first and second signals into a composite signal after the weight has been applied to at least one of the first and second signals; and
a controller for controlling the weighting circuit in accordance with an adaptive algorithm to thereby increase isolation between the first and second reception paths and a transmission path coupled to the transmission antenna.

15. The repeater of claim 14, wherein the weighting circuit includes one of a variable phase shifter for adjusting a phase of the one of the first and second signals and a variable attenuator for adjusting a gain of the one of the first and second signals.

16. The repeater of claim 14, further comprising:
a transmitter for transmitting a self-generated signal,
wherein the combiner is further configured to measure received signal strength of the composite signal during packet reception,
wherein the control circuit is further configured to determine an isolation metric between an output of the combiner and the transmitter based upon the measured received signal strength, and to control the weighting circuit in accordance with initial isolation metrics measured over successive weight settings, wherein the adaptive algorithm includes adjusting the weight to minimize the received signal strength of the self-generated signal and the isolation metric.

17. The repeater of claim 14, wherein the controller includes a digital to analog converter for setting weight values of the weight applied by the weighting circuit, and a microprocessor for controlling the digital to analog converter based upon the adaptive algorithm.

18. A frequency translating repeater for a wireless communication network, the repeater including first and second receivers coupled to first and second reception antennas and a transmitter coupled to a transmission antenna, the first and second receivers receiving on first and second frequencies until an initial packet detection, and receiving on a same frequency after the initial packet detection, the repeater comprising:
a directional coupler for receiving first and second signals from the first and second reception antennas, respectively, and outputting different algebraic combinations of the first and second signals to the first and second receivers; and
a baseband processing module coupled to the first and second receivers, the baseband processing module calculating multiple combinations of weighted combined signals, and selecting a particular combination of the calculated multiple combinations to determine first and second weights to apply to the first and second receivers.

19. The repeater according to claim 18, wherein the baseband processing module selects a combination having most optimum quality metric as the particular combination to determine the first and second weights, wherein the quality metric includes at least one of signal strength, signal to noise ratio, and delay spread.

20. The repeater according to claim 18, wherein the first and second reception antennas are first and second patch antennas, wherein the directional coupler is a 90° hybrid coupler including two input ports for receiving the first and second signals from the first and second patch antennas and two output ports for outputting the different algebraic combinations of the first and second signals so that the first and second receivers each have a substantially omni-directional combined antenna pattern.

21. The repeater according to claim 18, wherein the first and second reception antennas are first and second patch antennas, wherein the baseband processing module selects the particular combination to determine the first and second weights to apply to the first and second receivers so that substantially one of the first and second signals from the first and second patch antennas is received at the first and second receivers and an other of the first and second signals is canceled.

22. The repeater according to claim 18, wherein the baseband processing module applies the first and second weights by adjusting a gain and phase of the first signal or the second signal.

23. A repeater for a wireless communication network, the repeater comprising:
first and second receivers receiving first and second reception signals via first and second reception antennas;
first and second transmitters transmitting first and second transmission signals via first and second transmission antennas; and
a baseband processing module coupled to the first and second receivers and to the first and second transmitters, the baseband processing module configured to:
determine first and second reception weights to apply to the first and second reception signals; and
determine first and second transmission weights to apply to the first and second transmission signals.

24. The repeater of claim 23, wherein the baseband processing module is further configured to determine the first and second transmission weights and the first and second reception weights based upon an adaptive algorithm.

25. The repeater of claim 23, wherein the first and second transmitters transmit a self-generated signal, and the baseband processing module is further configured to:
measure received signal strength of a self-generated signal during packet reception;
determine an isolation metric between the first and second receivers and the first and second transmitters based upon the measured received signal strength of the self-generated signal;
determine the first and second transmission weights and the first and second reception weights in accordance with successive weight settings; and
adjust the first and second transmission weights and the first and second reception weights in accordance with the adaptive algorithm to increase the isolation metric between the first and second receivers and the first and second transmitters.

26. The repeater of claim 23, wherein the baseband processing module is further configured to adjust the first and second transmission weights based upon frequencies of the one of the first and second reception signals and the one of the first and second transmission signals.

27. The repeater of claim 23, wherein the first and second transmission antennas are first and second dipole antennas disposed on opposite sides of a same surface of a printed circuit board, and the first and second reception antennas are first and second patch antennas disposed on opposite surfaces of the printed circuit board.

28. The repeater of claim 1, further comprising:
a transmitter for transmitting a self-generated signal on the first and second transmission paths; and
a receiver for measuring a received signal strength during packet reception,
wherein the control circuit is further configured to determine an initial isolation metric between the reception path and the first and second transmission paths based upon at least the measured received signal strength, and to control the weighting circuit to adjust the weight in accordance with the adaptive algorithm, wherein the adaptive algorithm includes minimizing the received signal strength of the self-generated signal, wherein the self-generated signal is derived from a previously received signal.

29. The repeater of claim 1, further comprising:
a transmitter for transmitting a self-generated signal on the first and second transmission paths; and
a receiver for measuring a received signal strength during packet reception,
wherein the control circuit is further configured to determine an initial isolation metric between the reception path and the first and second transmission paths based upon at least the measured received signal strength, and to control the weighting circuit to adjust the weight in accordance with the adaptive algorithm, wherein the adaptive algorithm includes minimizing the received signal strength of the self-generated signal, wherein the self-generated signal is unrelated to a previously received signal.

30. The repeater of claim 14, further comprising:
a transmitter for transmitting a self-generated signal,
wherein the combiner is further configured to measure received signal strength of the composite signal during packet reception,
wherein the control circuit is further configured to determine an isolation metric between an output of the combiner and the transmitter based upon the measured received signal strength, and to control the weighting circuit in accordance with initial isolation metrics measured over successive weight settings, wherein the adaptive algorithm includes adjusting the weight to minimize the received signal strength of the self-generated signal and the isolation metric, wherein the self-generated signal is derived from a previously received signal.

31. The repeater of claim 14, further comprising:
a transmitter for transmitting a self-generated signal,
wherein the combiner is further configured to measure received signal strength of the composite signal during packet reception,
wherein the control circuit is further configured to determine an isolation metric between an output of the combiner and the transmitter based upon the measured received signal strength, and to control the weighting circuit in accordance with initial isolation metrics measured over successive weight settings, wherein the adaptive algorithm includes adjusting the weight to minimize the received signal strength of the self-generated signal and the isolation metric, wherein the self-generated signal is unrelated to a previously received signal.

32. The repeater of claim 25, wherein the self-generated signal is derived from a previously received signal.

33. The repeater of claim 25, wherein the self-generated signal is unrelated to a previously received signal.
